(19) United States
(12) Patent Application Publication
(10) Pub. No.: US 2005/0044180 A1
(43) Pub. Date: Feb. 24, 2005

(54) Method and system for determining information associated with an object

(76) Inventors: Jorg Lamers, Duisburg (DE); Aike Niemann, Monheim (DE); Daniel Kleine, Dusseldorf (DE)

Correspondence Address: WOODCOCK WASHBURN LLP, ONE LIBERTY PLACE, 46TH FLOOR, PHILADELPHIA, PA, 19103, US

(21) Appl. No.: 10/869,196

(22) Filed: Jun. 16, 2004

Related U.S. Application Data
(63) Continuation of application No. PCT/EP02/13925, filed on Dec. 9, 2002.

(30) Foreign Application Priority Data
Dec. 17, 2001 (DE) 101 61 968.5

(51) Int. Cl. G06F 15/16

(52) U.S. Cl. 709/218

(57) ABSTRACT

The present invention describes a system for determining information associated with an object, comprising a transponder associated with the object, wherein, upon being queried, the transponder responds with an Internet or intranet address and identifying information, a transponder reading device for querying the transponder and calling said Internet or intranet address, and a server at the Internet or intranet address for performing an access control using the identifying information. The present invention also describes a method for determination of information associated with an object, comprising associating an Internet or intranet address and identifying information with the object, and performing an access control at said Internet or intranet address based on said identifying information, wherein if said access control is successful, an Internet or intranet page is supplied including information about the object, and if said access control is unsuccessful, an error signal is supplied.

### CROSS REFERENCE TO RELATED APPLICATIONS

This application is a continuation of PCT/EP02/13925, filed Dec. 9, 2002 which claims the benefit of DE 101 61 968.5 filed Dec. 17, 2001, the complete disclosures of which are hereby incorporated by reference in their entirety.

### FIELD OF INVENTION

The invention relates to a method and a system for determining information associated with an object.

### BACKGROUND

One example of a method and system for determining information associated with an object is disclosed in WO 01/37082 A1. The system described in WO 01/37082 A1 has a transponder whose memory stores an identification which clearly identifies the transponder, and also an Internet address which an Internet page which is similarly associated with the object with which the transponder is associated. In line with WO 01/37082 A1, a transponder reading device reads the Internet address, and a communication connection is set up to the Internet page specified by the Internet address. When the communication connection has been set up, the appropriate information about the object which the Internet page provides is read by a client computer, to which the transponder reading device is coupled, and is shown to a user.

WO 01/73687 A2 describes a system in which a transponder reading device reads from a memory in a transponder an identification which identifies the transponder. In line with WO 01/73687 A2, the identification is transferred, together with an Internet address which is likewise read from the transponder memory, to a client computer using a radio link based on the Bluetooth™ protocol. The client computer uses the Internet address to set up a communication connection to the Internet page addressed by the Internet address using the Internet address, and appropriate information provided by means of the Internet page can then be requested by the client computer.

DE 196 12 406 C2 discloses an information storage medium and a method for overlaying and processing information, where the information storage medium has first information available in text form on a writeable and/or printable medium and additionally second added information, the first information being perceptible using a human's sensory organs. The second information cannot be perceived using a human's sensory organs, however, but certainly can be detected using a technical sensor. The first and second information have been overlaid on one another. The second information is additional information in relation to the first information and, when it has been read by the sensor, brings about a process for providing further information at an arbitrary time.

U.S. Pat. No. 6,119,935 describes a system for detecting a shopping list, where product information added to the product in the form of a barcode is scanned and corresponding additional information, which has likewise been added to the product in the form of a barcode, can be scanned and can be handled further by a computer which processes the scanned information.

### SUMMARY

The invention is based on the problem of specifying a method and a system for determining information associated with an object which allow information about an object to be provided easily and still allow a certain degree of protection to be achieved for the object.

The problem is solved by the method and the system for determining information associated with an object which have the features in line with the independent patent claims.

### BRIEF DESCRIPTION OF THE DRAWINGS

FIGS. 1a and 1b show a flowchart showing the individual method steps and the message interchange between the individual elements in line with an exemplary embodiment of the invention.

FIG. 2 shows a block diagram showing a passive transponder in line with an exemplary embodiment of the invention.

FIG. 3 shows a block diagram showing a client computer in line with an exemplary embodiment of the invention.

FIG. 4 shows a block diagram showing a first exemplary embodiment of the invention.

FIG. 5 shows a block diagram showing a second exemplary embodiment of the invention.

### DETAILED DESCRIPTION

In a method for determining information associated with an object, an Internet address or intranet address, stored in a memory in a transponder associated with the object, and an identification (likewise stored in the memory) which clearly identifies the transponder are read from said memory.

This is preferably done using a transponder reading device. The transponder reading device is preferably in a client computer which has been set up as a mobile computer unit, for example as a personal digital assistant (PDA) and/or as a mobile radio telephone, or alternatively the PDA may be integrated in the mobile radio telephone. In addition, the client computer may be a fixed computer, e.g. a personal computer or a computer integrated in a household appliance. Alternatively, the transponder reading device may be coupled to a computer without being an integral part of the computer.

Preferably, the client computer uses the Internet address or intranet address supplied to it, which has been read from the transponder's memory, via a communication interface which is provided in the client computer and by means of which the client computer is coupled to the Internet, generally to a communication network, via a telephone line or a radio link, in order to call an Internet page which is identified using the Internet address or using the intranet address.

Put another way, a communication connection is set up to a server computer which provides the from the Internet address or intranet address, preferably a URL address, and the server computer transfers the requested Internet page or intranet page to the client computer, preferably in line with the HTML protocol (Hypertext Markup Language protocol) or the WML protocol (Wireless Markup Language protocol).

In addition, the server computer transfers to the client computer an access control request message which is used to permit identification of the access rights to the information which relates to the object. The client computer transmits the identification which is read from the transponder's memory to the server computer as access information in an access information message on the basis of the access control request message, and, having received this, the server computer performs an access control. Put another way, the server computer checks whether the identification is actually associated with a transponder and, by this means, with an object for which the information is intended to be provided. This is preferably done by means of comparison with a database which is stored in the server computer, alternatively by means of comparison with data which are stored in a database to which the server computer has access and which stores the objects and the identifications which identify the transponder associated with the object.

If the access control is successful, then the server computer transfers the desired information in the form of an additional Internet page or intranet page to the client computer, where it is shown to the user of the client computer, with the result that information about the object has been made accessible to the user in this way.

If the access control is unsuccessful, however, that is to say that the transponder is not a transponder which is known to the server computer “as authorized”, then the server computer produces an error signal.

A system for determining information associated with an object preferably has a transponder which is clearly associated with an object, for example, the transponder's memory storing an Internet address or an intranet address and an identification which clearly identifies the transponder.

The system also has a transponder reading device which has been set up such that the information which is stored in the transponder's memory can be read. The transponder reading device is preferably integrated in a client computer, which may be in mobile or fixed form, or alternatively is coupled thereto. The client computer also has a communication interface which has been set up such that it can be used for communication in line with the Transport Control Protocol (TCP)/Internet Protocol (IP). In addition, the client computer stores an Internet browser program (also called a web browser program), for example the program Internet Explorer™ or the program Netscape Navigator™.

The communication interface and a telecommunication network, for example a mobile radio network or a landline network, can be used to couple the client computer to a server computer, with the server computer providing the respective Internet page or intranet page identified by the Internet address or intranet address.

The server computer is in a form such that calling the Internet page or intranet page initiates an access control which is used to control whether the entity calling the Internet page or intranet page is able to prove, i.e. particularly whether the transponder identification indicates, that a transponder is involved which is associated with an object for which access to the Internet pages or intranet pages can actually be permitted. The access control is preferably performed using the transponder's identification, which means that this allows the originality of an object to be controlled directly on the basis of the clear association between the transponder and the object.

The invention can clearly be seen in that the memory in a transponder associated with an object stores a web link, that is to say a web address, put another way an Internet address or intranet address. When the respective Internet page or intranet page is called, that is to say when the Internet address or the intranet address is transferred via the Internet, the web link does not necessarily lead directly to a web page containing information which is intended to be associated with the object, preferably product information associated with the object, but rather leads first of all to an object-neutral, preferably a product-neutral start page.

When this Internet start page or intranet start page is called, the server computer first performs an access control, preferably by requesting the identification which is stored in the transponder and is read by the client computer.

Only after the check on the identification and hence a successful access control is the Internet page or intranet page with the actual object information called and provided for the requesting entity, for example the client computer.

This clearly corresponds to a key/lock principle.

The invention has a multiplicity of advantages over the prior art. Particularly in comparison with the system from WO 01/37082 A1, the invention achieves integrated product protection, in general integrated protection for the information which is associated with the object and is provided via the Internet page. If the object is, by way of example, a product which is for sale or has been sold which has been fitted with the transponder, then the effect achieved by the inventive combination of the transponder's identification and the Internet address or intranet address is that it is possible to request only original products on the basis of the access control service information, in general information which actually relates to the original products and possibly also service information provided which is associated with the objects. In addition, products which are not original, that is to say copies, can be located, particularly if location information is available.

Preferred developments of the invention can be found in the dependent claims.

In line with one refinement of the invention, the Internet address is stored in the transponder memory in compressed form, for example only a portion of the Internet address or intranet address, preferably the “page.de” portion, where “page” indicates the respective Internet page or intranet page, may be stored instead of the normal full Internet address or intranet address “http://www.page.de”. In this case, the client computer decompresses the compressed Internet address or intranet address to produce the full Internet address or intranet address, that is to say clearly extends it.

In this connection, the invention uses an inherently customary mechanism, provided by a present-day Internet browser program, in order to achieve an additional saving in the storage space which is available only to a very limited extent anyway in the transponder memory. The decompressed, that is to say the full, Internet address is used by the client computer to call the Internet page or the intranet page.

In addition, the Internet address or the intranet address may be stored in the transponder memory in encrypted form. In line with this refinement of the invention, the encrypted Internet address or the encrypted intranet address is decrypted in the client computer, and only after encryption is the Internet page or the intranet page called by the client computer.

In line with another refinement of the invention, the access control, particularly the identification, can be protected cryptographically.

This can be done, by way of example, by using the identification to form a digital signature using a private key, preferably from the manufacturer, for the respective object and storing the digital signature in the transponder's memory too.

The transponder memory can be split into a freely accessible first memory area and a second memory area which is not freely accessible.

The memory area which is not freely accessible stores the transponder's identification, which means that the identification cannot be changed without authorization. However, the digital signature may be stored in the freely accessible memory area without risk, since explicitly only the manufacturer of the object can actually have formed this signature anyway using his secret key.

The transponder memory, preferably the freely accessible first memory area, may store additional information, for example the date of purchase, that is to say a date on which the object has been purchased from a trader by a user. Alternatively or in addition, details of the trader selling the object may be stored.

If the date of purchase is stored as additional information in the transponder memory, then one refinement of the invention provides for guarantee information or services to be provided as part of the provision of a guarantee for the object when the Internet page or intranet page is called and upon successful access control.

If the trader details, optionally likewise with cryptographical protection, are additionally stored in the transponder memory, then it is a simple matter, upon unsuccessful access control, for the trader who has produced the copy to be determined directly. In this way, the sales routes of the original products and also of copies are more easily reconstructed, which improves the product protection for a respective product.

In addition, the object may be provided with a global positioning system (GPS), which permits local product position finding upon successful or else incorrect access control. This is advantageous particularly within the context of product position finding in the event of theft or else in the event of recall actions.

It should be noted in this connection that, although only a passive transponder is described within the context of the exemplary embodiments below, the invention may also use an active transponder.

Exemplary embodiments of the invention are shown in the Figs. and are explained in more detail below. Similar elements have been provided with identical reference symbols in the Figs.

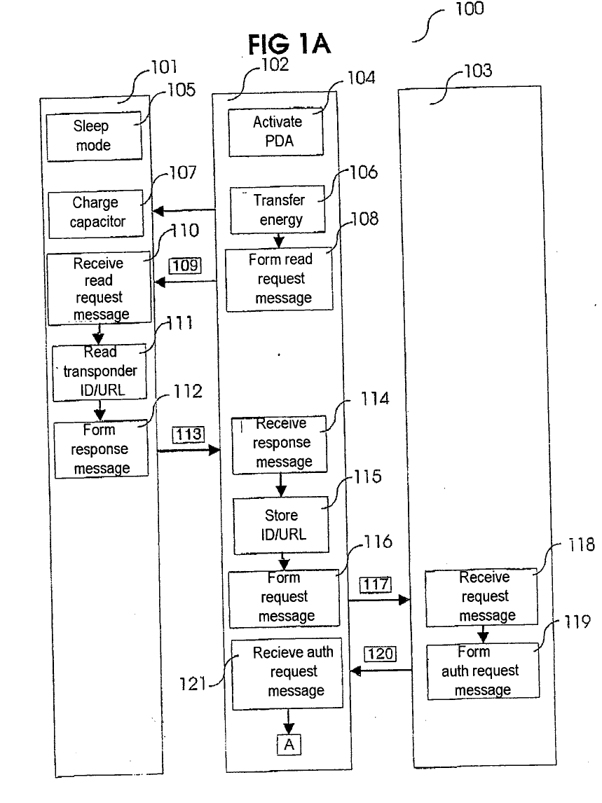

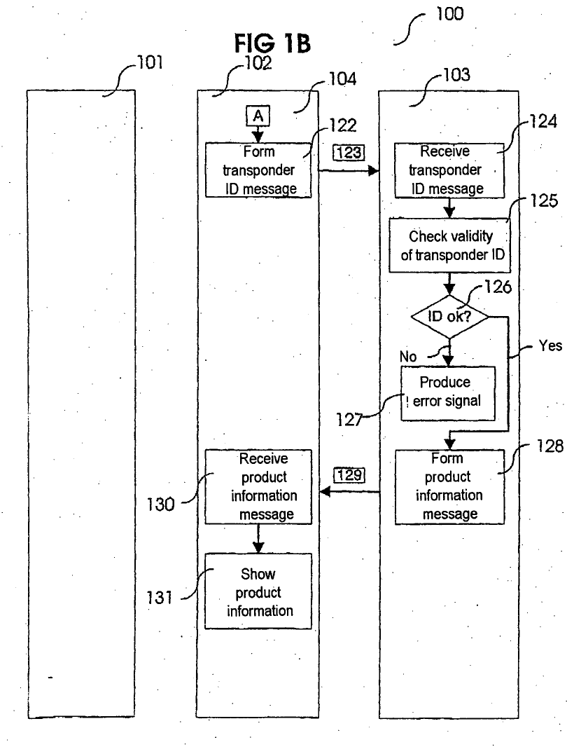

FIG. 1a and FIG. 1b show a block diagram 100 of the individual method steps which are carried out in line with an exemplary embodiment of the invention and also an overview of the messages which are interchanged between the individual apparatuses in the inventive system.

The system has a transponder 101, a client computer 102, in line with FIG. 1a and FIG. 1b a personal digital assistant (PDA), and also a server computer 103. The client computer is coupled to the transponder via a radio communication connection and to the server computer via a mobile radio communication connection and/or a landline communication connection.

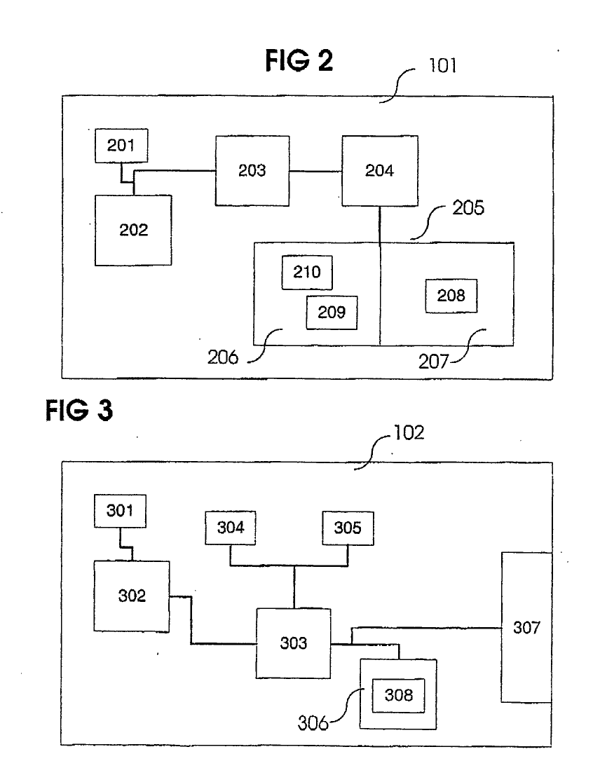

FIG. 2 shows the structure of the transponder 101 in its individual components. The transponder 101 has an antenna 201 which the transponder 101 can use to pick up energy or to receive or send messages. The antenna 201 has a capacitor 202 coupled to it such that energy received via the antenna 201 is stored in the capacitor 202.

Once the capacitor 202 has been charged, it serves as an energy source for operating the other components contained in the transponder 101.

In addition, the antenna and the capacitor 202 have a transceiver 203 coupled to them, and the latter has a logic circuit 204 coupled to it which is in turn coupled to an electronic memory 205 which has a first memory area 206, to which a user has free write and read access, and a second memory area 207, to which a user has only read access.

In line with the exemplary embodiments, the transponder 101 is clearly associated with a respective product, particularly fitted on or in this respective product.

The second memory area 207 stores an identification 208 which clearly identifies the transponder 101 itself and, in line with this embodiment, is in the form of a 40-bit code. The first memory area 206 also stores additional information 209, in line with these exemplary embodiments a date of purchase on which the respective product is fitted on or in the transponder unit and has been sold to an end user, and also a trader identification for clearly identifying the trader selling the product. The first memory area 206 also stores an Internet address or intranet address 210 which points to a start page for the manufacturer of the product with which the transponder 101 is associated.

The trader identification may be in encrypted form or may be protected using the secret key associated with the trader for the purpose of clearly authenticating the respective trader using a digital signature.

FIG. 3 shows an outline of a personal digital assistant 102 in the form of a client computer in line with the first exemplary embodiment of the invention.

The PDA 102 likewise has an antenna 301, which is coupled to an RF transceiver 302. The RF transceiver 302 is coupled to a central control unit (central processing unit, CPU) 303 which, for its part, is coupled to a keypad 304 and to a screen 305. The PDA 102 also has a communication interface 307 which is designed for data communication via the Internet or in line with an Internet protocol (particularly in line with the transport control protocol (TCP) or the Internet protocol (IP)), the communication interface 307 having been set up for communication via a mobile radio network and/or a landline network, for example an ordinary telephone network.

In addition, the CPU 303 is coupled to a memory 306. The memory 306 stores a web browser program 308 which can interchange data coded on the basis of the wireless markup language (WML).

If the PDA 102 is activated in a first step (cf. FIG. 1a) for the purpose of reading the transponder (step 104), then energy is transferred in a further step (step 106) from the PDA 102 to the, which, at the start of the method, is in a sleep mode 105, that is to say in an inactive mode.

The energy is received by the transponder 101 via its antenna 201, and the capacitor 202 is charged with the received energy (step 107).

Next, the PDA 102 produces a read request message 109 (step 108) and sends it to the transponder via a radio link, in this exemplary embodiment in line with the ISO standard 15693.

The read request message 109 is received by the transponder 101 (step 110), and following appropriate decoding of the read request message 109 the transponder 101 reads the Internet address or intranet address stored in the first memory area 206 and also the transponder ID, that is to say the identification 208 which clearly identifies the transponder 101, from the second memory area 207 (step 111), and a response message 113 is produced and sent to the PDA (step 112).

When the response message 113 has been received by the PDA 102 (step 114), the data determined from the response message 113, that is to say, in particular, the Internet address or intranet address 210 and the transponder ID 208, and possibly also additional information 209 which is contained in the first memory area and is likewise transferred together with the response message 113, are stored in the memory 306 in the PDA 102 (step 115).

In a further step (step 116), a request message 117 is produced, which contains the Internet address 210 and is used to request transfer of the Internet page or intranet page addressed by the Internet address or intranet address 210.

In one alternative refinement of the invention, the first memory area 206 stores the Internet address or intranet address in compressed form, that is to say just in line with the format “page.de”, for example, where “page” contains merely the address indicated before the “.de” domain.

Hence, in line with this alternative refinement of the invention, only the “page.de” string is transferred to the PDA in the response message 113, and the PDA uses the Internet browser program 308 stored in the memory 306 in the PDA 102 to decompress this string, that is to say to add the further “http://www.” details to it, and then transfers it as the full Internet address or full intranet address “http://www.page.de” to the server computer 103 in the request message 117 via the Internet/intranet.

The server computer 103 receives the request message 117 (step 118), decodes it and produces and sends an authentication request message 120 to the PDA 102 (step 119).

The server computer 103 uses the authentication request message 120 to ask the PDA 102 to identify and authenticate the transponder 101, and above this the product clearly associated with the transponder.

When the authentication request message 120 has been received (step 121), the PDA 102 reads the transponder ID from the memory 306, and a transponder ID message 123 is produced and is sent to the server computer 103 (step 122).

The server computer 103 receives the transponder ID message 123 (step 124), decodes it and checks the validity of the transponder ID contained in the transponder ID message 123 (step 125).

This is done using a database which is either stored in the server computer 103 itself or can be accessed by the server computer 103, the database respectively storing for a product with which a transponder is associated and the respective associated unique transponder ID.

This means that the database contains the information regarding whether a permissible product exists for the respective transponder ID or whether the product associated with the transponder is a copy, for example.

If the transponder ID is not in order (step 126), put another way if the access control fails, then the server computer 103 produces an error signal (step 127).

On the basis of the error signal, if the transponder ID message 123 additionally contains the trader details, then these can be evaluated and the respective trader selling the associated product can be contacted, which means that it is a very simple matter to spot the channels of distribution for copies.

If the access control is successful, put another way if the check on the transponder ID had a positive outcome, then the Internet page or the intranet page is called from the Internet page or the intranet page which was addressed, and the product information contained therein is produced by the server computer 103 as a product information message 129 and is sent to the PDA 102 (step 128).

The product information message 129 preferably contains the following product information: general product information, such as the date of manufacture or the shelf life of the respective product, instructions for use, for example including recipes for a foodstuff which use the respective foodstuff, information within the context of product advice, for example an e-mail address, a telephone number etc., in general a contact address for an entity which provides product advice, product-specific advertising details, preferably advice of new products or else advice of products related to the respective product, guarantee information, hazardous goods information, information on first aid measures, for example advice relating to measures in a situation in which a detergent has been swallowed, information relating to the compatibility of products, preferably in a situation in which two products have been provided with a transponder in line with the invention, for example when the first product is a paint undercoat and the second product is a paint, details about what paint retains well on a respective paint undercoat, or for example when the first product is a hair dye and the second product is a shampoo, details about what shampoo is kindest to the respective hair dye.

The PDA 102, in turn, receives the product information message 129 (step 130), decodes it and uses the stored Internet browser program to show the product information to the user of the PDA 102 (step 131).

If the additional information 209 stores the date of purchase, then an alternative refinement has provision for this date to be transmitted to the server computer 103 with the transponder ID message 123 and then for appropriate actions to be taken as part of a guarantee service over the Internet/intranet.

In this context, it should be noted that one alternative refinement of the invention has provision for the first memory area 206 to store a transponder ID 208 which has been encrypted using a secret key from the manufacturer of the product with which the transponder 101 is associated, which means that enhanced cryptographically protected authentication and hence more reliable access control in the server computer is made possible when said transponder ID is evaluated, that is to say when it is also transmitted to the PDA 102 and to the server computer 103 in the corresponding messages.

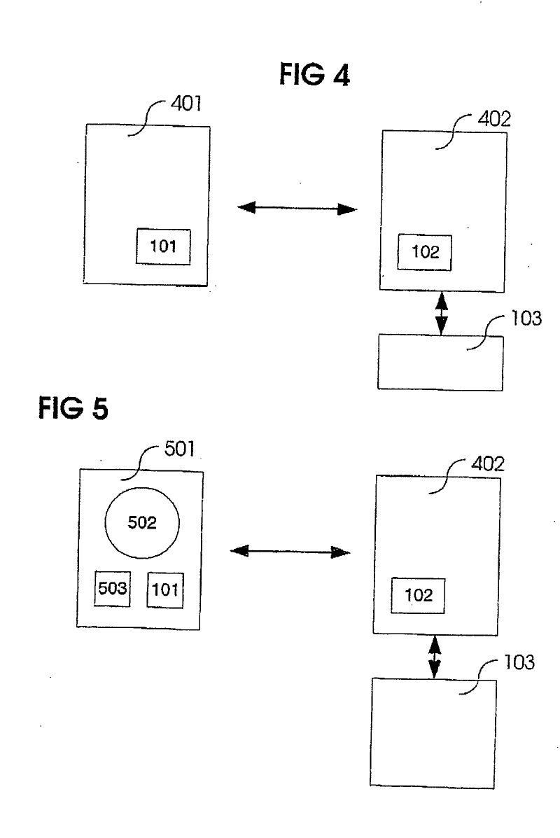

FIG. 4 shows a first exemplary embodiment, in which the transponder 101 has been fitted to a detergent package 401 and in which the client computer 102 is integrated in a washing machine 402 having an appropriate screen and an appropriate keypad.

The washing machine 402 itself likewise has a communication interface which allows communication over the Internet/intranet. The client computer 102 also has a transponder reading device which is integrated in the washing machine 402 and can be used to read the information from the memory in the transponder 101. The communication between the client computer 102, the washing machine 402 and the server computer 103 takes place via a communication landline network.

In line with this exemplary embodiment, it is a very simple matter for a purchaser of the product, in this exemplary embodiment a detergent, 401 to retrieve more detailed information, for example tips or advice on particular wash cycles and/or on metering the detergent, which is provided by the product manufacturer of the detergent 401 using the server computer 103, by placing the detergent 401 only into the reading area of the transponder reading device in the washing machine 402 and using the washing machine 402 to set up the appropriate communication connection to the Internet page or intranet page which contains the product information.

FIG. 5 shows a second exemplary embodiment of the invention, in which the product is a clock 501 in which with a dial 502, the transponder 101 and also a GPS receiver 503 being integrated in said clock 501. In this case, the client computer 102 is in the form of a PDA, and the communication likewise takes place as shown in FIG. 1a and FIG. 1b.

If the server computer 103 produces an error signal in this case, then in line with this exemplary embodiment the GPS system is activated and the local position of the clock 501 is determined using the GPS system 503 part of the clock 501.

In an alternative refinement of the invention, verification of the transponder ID with a negative outcome results in the server computer 103 using the IP address of the client computer 102 to determine the respective point of sale.

In line with another alternative refinement of the invention, provision is made for the system described above to be used within the context of a product recall action.

In this case, an owner of a respective product brings the product to a client computer 102 in order to determine whether his product 401, 501 has already been replaced or subjected to appropriate repair or handling, or is possibly not affected by the product recall action in question at all.

In summary, the invention makes it possible, particularly on account of the access control, in line with the invention to retrieve information about each individual product selectively and individually in a very simple manner and to request information not just about a whole product group.

The disclosures of each patent, patent application, and publication cited or described in this document are hereby incorporated herein by reference, in their entireties.

Various modifications of the invention, in addition to those described herein, will be apparent to those skilled in the art from the foregoing description. Such modifications are also intended to fall within the scope of the appended claims.

1. A system for determining information associated with an object, comprising:
a transponder associated with the object, wherein, upon being queried, the transponder responds with an Internet or intranet address and identifying information;
a transponder reading device for querying the transponder and calling said Internet or intranet address; and
a server at the Internet or intranet address for performing an access control using the identifying information.

2. The system of claim 1, wherein the server determines whether a permissible object exists for said the identifying information.

3. The system of claim 1, wherein if said access control is successful, the server supplies an Internet or intranet page including information about the object, and if said access control is unsuccessful, the server supplies an error signal.

4. The system of claim 1, wherein the Internet or intranet address is stored in and read from the transponder in compressed form, and subsequently decompressed.

5. The system of claim 1, wherein the Internet or intranet address is stored in and read from the transponder in encrypted form, and subsequently decrypted.

6. The system of claim 1, wherein the identifying information is stored in and read from the transponder in encrypted form, and subsequently decrypted.

7. The system of claim 1, wherein the access control is performed using a digital signature.

8. The system of claim 1, wherein the transponder stores additional information about the object.

9. A method for determination of information associated with an object, comprising:
associating an Internet or intranet address and identifying information with the object; and
performing an access control at said Internet or intranet address based on said identifying information, wherein if said access control is successful, an Internet or intranet page is supplied including information about the object, and if said access control is unsuccessful, an error signal is supplied.

10. The method of claim 13, wherein a transponder is associated with the object for storing said Internet or intranet address and identifying information.

11. The method of claim 14, wherein a transponder reading device is provided for calling said Internet or intranet address.

12. The method of claim 14, wherein the Internet or intranet address is stored in and read from the transponder in compressed form, and subsequently decompressed.

13. The method of claim 14, wherein the Internet or intranet address is stored in and read from the transponder in encrypted form, and subsequently decrypted.

14. The method of claim 13, wherein the identifying information is stored in and read from the transponder in encrypted form, and subsequently decrypted.

15. The method of claim 13, wherein the access control is performed using a digital signature.

16. The method of claim 13, further comprising replying to an access control message by supplying said identifying information.

17. The method of claim 13, wherein the transponder stores additional information about the object.

18. The method of claim 17, wherein the additional information is a date on which the object was purchased.

19. The method of claim 17, wherein the additional information is details about the trader selling the object.

20. The method of claim 13, wherein if said access control is unsuccessful, the local position of the object is determined.

21. The method of claim 13, wherein if said access control is unsuccessful, a trader selling the object is identified.
